(19) United States
(12) Patent Application Publication
(10) Pub. No.: US 2007/0127152 A1
(43) Pub. Date: Jun. 7, 2007

(54) Disk apparatus and method of data read and write

(75) Inventor: Koji Suwa, Kato (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/375,196

(22) Filed: Mar. 15, 2006

(30) Foreign Application Priority Data
Dec. 2, 2005 (JP) 2005-349865

(51) Int. Cl. G11B 5/596; G11B 21/02

(52) U.S. Cl. 360/77.08; 360/75

(57) ABSTRACT

A disk apparatus and a method of data read/write are provided in which even when off-track error occurs at the end sector, the occurrence of the off-track error is detected reliably. Data is read from and/or written into a track on a disk on each sector. An end sector identification number is acquired that identifies the end sector related to the read and/or write of the data. Then, when data of the end sector corresponding to the acquired end sector identification number is read and/or written, the identification number of the next sector of the end sector is read. Then, it is determined whether the read-out identification number of the next sector is consecutive to said end sector identification number. When determined as consecutive, the data read from the end sector is outputting, or alternatively the data to be written into the end sector is received from the outside.

### CROSS-REFERENCE TO RELATED APPLICATIONS

This Nonprovisional application claims priority under 35 U.S.C § 119(a) on Patent Application No. 2005-349865 filed in Japan on Dec. 2, 2005, the entire contents of which are hereby incorporated by reference.

### BACKGROUND OF THE INVENTION

The present invention relates to a disk apparatus and a method of data read and write in which even when off-track error is caused by dust, vibration, and the like, data garbling is avoided in particular in data having been read from the end sector or alternatively in data having been written into the end sector.

With the progress of scale expansion in computer systems in recent years, further enhancement is required in the capacity of disk apparatuses for storing data. Thus, information need be recorded at high density on a disk serving as a storage medium, while the data recorded at high density need reliably be reproduced from the disk.

In a prior art disk apparatus, tracking control is performed on a head. The head is controlled and caused to scan along a desired track position on the disk. Nevertheless, vibration, dust, and the like provided from the outside could cause off-track error in which the head deviates from the center position of the track so that a reproduction signal cannot correctly be read or alternatively a recording signal cannot correctly be written.

In the prior art disk apparatus, the occurrence of off-track error is determined on the basis of whether the width of deviation of the focus point of the head relative to the disk recording surface exceeded a predetermined value. Thus, in order that excessively frequent occurrence should be suppressed in read error for the data stored in the disk or alternatively in write error for the data to be written into the disk, the above-mentioned predetermined value used as the criterion for the width of the deviation is set at a large value so that excessively frequent detection of off-track error is avoided. Accordingly, for example, during data read in a predetermined sector, in a case that minute vibration which cannot be recognized by off-track detection has caused the head to move onto another track located at an adjacent position and that the data recorded on a sector of the adjacent track has still been read correctly, the data on the adjacent track is treated as if it were appropriate data.

In order to solve this problem, for example, Japanese Patent Application Laid-Open No. 2002-25236 discloses a disk drive apparatus in which consecutiveness is detected in information (such as sector IDs) that identifies sectors. Then, when the sector IDs are consecutive to each other, it is determined that no off-track error has occurred.

### BRIEF SUMMARY OF THE INVENTION

The present invention has been devised in view of this situation. An object of the present invention is to provide a disk apparatus and a method of data read and write in which even when off-track error occurs at the end sector, the occurrence of the off-track error is detected reliably, so that the transmission of read-out data to a host computer or alternatively the receiving of to-be-written data from a host computer is avoided in advance.

In order to achieve the above-mentioned object, a disk apparatus according to a first invention is characterized by a disk apparatus having: a head for reading and/or writing data on each sector from or to a track on a disk; and a head position control unit for controlling the position of the head on said disk, comprising: means for acquiring an end sector identification number that identifies the end sector related to the read and/or write of the data; next sector reading means for reading an identification number of the next sector of the end sector when data of the end sector corresponding to the acquired end sector identification number is read and/or written; means for determining whether the read-out identification number of the next sector is consecutive to said end sector identification number; and means for outputting the data read from the end sector, or alternatively receiving from the outside the data to be written into the end sector, when the preceding means has determined as consecutive.

A disk apparatus according to a second invention is characterized by a disk apparatus having: a head for reading and/or writing data on each sector from or to a track on a disk; and a head position control unit for controlling the position of the head on said disk, comprising: means for acquiring an end sector identification number that identifies the end sector related to the read and/or write of the data; adjacent sectors reading means for reading an identification number of the next sector and an identification number of the preceding sector relative to the end sector when data of the end sector corresponding to the acquired end sector identification number is read and/or written; means for determining whether the identification number of the next sector and the identification number of the preceding sector having been read are consecutive to said end sector identification number; and means for outputting the data read from the end sector, or alternatively receiving from the outside the data to be written into the end sector, when the preceding means has determined as consecutive.

A disk apparatus according to a third invention is characterized by a disk apparatus having: a head for reading and/or writing data on each sector from or to a track on a disk; and a head position control unit for controlling the position of the head on said disk, comprising: means for acquiring an end sector identification number that identifies the end sector related to the read and/or write of the data; means for generating a new end sector identification number by incrementing by unity the end sector identification number, when data of the end sector corresponding to the acquired end sector identification number is read and/or written; means for determining whether the sector identification numbers up to the generated new end sector identification number are consecutive to each other; and means for outputting the data read from the other sectors with excluding the data read from the sector corresponding to the new end sector identification number, or alternatively receiving from the outside the data to be written into the sectors other than the sector corresponding to the new end sector identification number, when the preceding means has determined as consecutive.

A disk apparatus according to a fourth invention is characterized by a disk apparatus of the first invention further comprising means for determining whether off-track retry has been generated before the end of a sector located at a position generated by decrementing by unity the acquired end sector identification number, wherein only when the means has determined that off-track retry has been generated, said next sector reading means reads the identification number of the next sector of said end sector.

A disk apparatus according to a fifth invention is characterized by a disk apparatus of the second invention further comprising means for determining whether off-track retry has been generated before the end of a sector located at a position generated by decrementing by unity the acquired end sector identification number, wherein only when the means has determined that off-track retry has been generated, said adjacent sectors reading means reads the identification number of the next sector and the identification number of the preceding sector relative to said end sector.

A method of data read and write according to a sixth invention is characterized by a method of data read and write used in a disk apparatus for reading and/or writing data on each sector from or to a track on a disk, comprising the steps of: acquiring an end sector identification number that identifies the end sector related to the read and/or write of the data; reading an identification number of the next sector of the end sector when data of the end sector corresponding to the acquired end sector identification number is read and/or written; determining whether the read-out identification number of the next sector is consecutive to said end sector identification number; and outputting the data read from the end sector, or alternatively receiving from the outside the data to be written into the end sector, when determined as consecutive.

A method of data read and write according to a seventh invention is characterized by a method of data read and write used in a disk apparatus for reading or writing data on each sector from or to a track on a disk, comprising the steps of acquiring an end sector identification number that identifies the end sector related to the read and/or write of the data; reading an identification number of the next sector and an identification number of the preceding sector relative to the end sector when data of the end sector corresponding to the acquired end sector identification number is read and/or written; determining whether the identification number of the next sector and the identification number of the preceding sector having been read are consecutive to said end sector identification number; and outputting the data read from the end sector, or alternatively receiving from the outside the data to be written into the end sector, when determined as consecutive.

A method of data read and write according to an eighth invention is characterized by a method of data read and write used in a disk apparatus for reading and/or writing data on each sector from or to a track on a disk, comprising the steps of: acquiring an end sector identification number that identifies the end sector related to the read and/or write of the data; generating a new end sector identification number by incrementing by unity the end sector identification number, when data of the end sector corresponding to the acquired end sector identification number is read and/or written; determining whether the sector identification numbers up to the generated new end sector identification number are consecutive to each other; and outputting the data read from the other sectors with excluding the data read from the sector corresponding to the new end sector identification number, or alternatively receiving from the outside the data to be written into the sectors other than the sector corresponding to the new end sector identification number, when determined as consecutive.

A method of data read and write according to a ninth invention is characterized by a method of data read and write of the sixth invention further comprising the steps of determining whether off-track retry has been generated before the end of a sector located at a position generated by decrementing by unity the acquired end sector identification number; and reading the identification number of the next sector of said end sector only when determined that off-track retry has been generated.

A method of data read and write according to a tenth invention is characterized by a method of data read and write of the seventh invention further comprising the steps of determining whether off-track retry has been generated before the end of a sector located at a position generated by decrementing by unity the acquired end sector identification number; and reading the identification number of the next sector and the identification number of the preceding sector relative to said end sector only when determined that off-track retry has been generated.

A method of data read and write according to an eleventh invention is characterized by a method of data read and write of any one of the sixth through the tenth inventions further comprising the step of executing data read and write on the basis of a data transfer pointer indicating a sector serving as a data transfer target and a read-write pointer indicating a sector serving as a target of data read and write, wherein said data transfer pointer indicates a range extending from a read start sector to said end sector, while said read-write pointer indicates a range extending from a read-write start sector to a predetermined sector that follows said end sector.

According to the first and the sixth inventions, an end sector identification number is acquired that identifies the end sector related to the read and/or write of the data. Then, when data of the end sector corresponding to the acquired end sector identification number is read and/or written, the identification number of the next sector of the end sector is read. Then, it is determined whether the read-out identification number of the next sector is consecutive to said end sector identification number. When it is determined that the identification number of the next sector is consecutive to the end sector number, the data read from the end sector is outputting, or alternatively the data to be written into the end sector is received from the outside. Thus, when off-track error occurs at the end sector, since the identification number of the next sector becomes inconsecutive to the identification number of the end sector, read-out data is not outputting or alternatively to-be-written data is not received from the outside. Thus, only when no off-track error has occurred, read-out data is outputting, or alternatively to-be-written data is received from the outside. This ensures the validity of the read-out data or the written-in data.

According to the second and the seventh inventions, an end sector identification number is acquired that identifies the end sector related to the read and/or write of the data. Then, when data of the end sector corresponding to the acquired end sector identification number is read and/or written, the identification number of the next sector and the identification number of the preceding sector relative to the end sector are read. Then, it is determined whether the identification number of the next sector and the identification number of the preceding sector having been read are consecutive to said end sector identification number. Then, when it is determined that the identification number of the next sector and the identification number of the preceding sector having been read are consecutive to said end sector identification number, the data read from the end sector is outputting, or alternatively the data to be written into the end sector is received from the outside. Accordingly, even in a case that off-track error has occurred immediately before the reading of the end sector and that still the data has been tried to be read out intact, or alternatively in a case that data has been tried to be written in intact, the occurrence of the off-track error is detected reliably since consecutiveness is not achieved with the identification number of the preceding sector. Thus, even when off-track error occurs at any timing, read-out data is not outputting or alternatively to-be-written data is not received from the outside. This ensures the validity of the read-out data or the written-in data.

According to the third and the eighth inventions, an end sector identification number is acquired that identifies the end sector related to the read and/or write of the data. Then, when data of the end sector corresponding to the acquired end sector identification number is read and/or written, a new end sector identification number is generated by incrementing by unity the end sector identification number. Then, it is determined whether the sector identification numbers up to the generated new end sector identification number are consecutive to each other. When it is determined that the sector identification numbers up to the generated new end sector identification number are consecutive to each other, the data read from the other sectors with excluding the data read from the sector corresponding to the new end sector identification number is outputting, or alternatively the data to be written into the sectors other than the sector corresponding to the new end sector identification number is received from the outside. Thus, in a state that a sector which follows the end sector and intrinsically does not store to-be-read data or should not accept to-be-written data is tentatively considered as the end sector, whether the identification number of the sector consecutive is determined by the same method as the prior art, so that easy determination is achieved whether off-track error has occurred at the intrinsic end sector. Further, when no off-track error has occurred, data transmission is performed with excluding the data of the portion having been considered as the new end sector. This realizes the reading of correct data the validity of which is ensured.

According to the fourth and the ninth inventions, an end sector identification number is acquired that identifies the end sector related to the read and/or write of the data. Then, it is determined whether off-track retry has been generated before the end of a sector located at a position generated by decrementing by unity the acquired end sector identification number. When it is determined that off-track retry has been generated, the identification number of the next sector of the end sector is read. Then, it is determined whether the read-out identification number of the next sector is consecutive to said end sector identification number. When it is determined that the identification number of the next sector is consecutive to the end sector number, the data read from the end sector is output, or alternatively the data to be written into the end sector is received from the outside. Accordingly, when no off-track retry has been generated, it is determined that no off-track error has occurred at any sector up to the end sector. Thus, the validity of the data is ensured without the necessity of improving the sector read processing. When off-track retry has been generated, similarly to the first and the sixth inventions, it is sufficient to determine whether the identification number of the next sector of the end sector is consecutive to the end sector identification number. This reduces the load of arithmetic operation in the processing of determining whether the sector IDs are consecutive to each other. Thus, only when no off-track error has occurred, read-out data is output, or alternatively to-be-written data is received from the outside. This simple processing ensures the validity of the read-out data or the written-in data.

According to the fifth and the tenth inventions, an end sector identification number is acquired that identifies the end sector related to the read and/or write of the data. Then, it is determined whether off-track retry has been generated before the end of a sector located at a position generated by decrementing by unity the acquired end sector identification number. When it is determined that off-track retry has been generated, the identification number of the next sector and the identification number of the preceding sector are read. Then, it is determined whether the identification number of the next sector and the identification number of the preceding sector having been read are consecutive to the end sector identification number. When it is determined that the identification number of the next sector and the identification number of the preceding sector are consecutive to the end sector number, the data read from the end sector is output, or alternatively the data to be written into the end sector is received from the outside. Accordingly, when no off-track retry has been generated, it is determined that no off-track error has occurred at any sector up to the end sector. Thus, the validity of the data is ensured without the necessity of improving the sector read processing. When off-track retry has been generated, similarly to the second and the seventh inventions, it is sufficient to determine whether the identification number of the next sector of the end sector is consecutive to the end sector identification number. This reduces the load of arithmetic operation in the processing of determining whether the sector IDs are consecutive to each other. Thus, only when no off-track error has occurred, read-out data is output, or alternatively to-be-written data is received from the outside. This simple processing ensures the validity of the read-out data and/or the written-in data.

According to the eleventh invention, data read and write are executed on the basis of a data transfer pointer indicating a sector serving as a data transfer target and a read-write pointer indicating a sector serving as a target of data read and write, while the data transfer pointer indicates a range extending from a read start sector to the end sector, and while the read-write pointer indicates a range extending from a read-write start sector to a predetermined sector that follows the end sector. Accordingly, in contrast to the prior art where a data transfer pointer and a read-write pointer indicate the same range, the data transfer pointer and the read-write pointer of the present invention indicate distinct ranges. By virtue of this, data which should not be read, for example, the data stored in a sector that follows the end sector, is prevented from being output, or alternatively from being received from the outside. That is, data the validity of which is ensured is solely output, or alternatively received from the outside.

The above and further objects and features of the invention willmore fully be apparent from the following detailed description with accompanying drawings.

### BRIEF DESCRIPTION OF THE SEVERAL VIEWS OF THE DRAWINGS

FIG. 1 is a block diagram showing the configuration of a disk apparatus according to Embodiment 1 of the present invention.

FIG. 2 is an illustrative diagram showing the sector configuration of a disk.

FIG. 3 is a flow chart showing a procedure of data read processing in a DSP of a disk apparatus according to Embodiment 1 of the present invention.

FIGS. 4A and 4B are illustrative diagrams showing sector IDs that are read when off-track error has occurred and when no off-track error has occurred.

FIG. 5 is a flow chart showing a procedure of data write processing in a DSP of a disk apparatus according to Embodiment 1 of the present invention.

FIG. 6 is a flow chart showing a procedure of data read processing in a DSP of a disk apparatus according to Embodiment 2 of the present invention.

FIGS. 7A and 7B are illustrative diagrams showing sector IDs that are read when off-track error has occurred and when no off-track error has occurred.

FIG. 8 is a flow chart showing a procedure of data write processing in a DSP of a disk apparatus according to Embodiment 2 of the present invention.

FIG. 9 is a flow chart showing a procedure of data read processing in a DSP of a disk apparatus according to Embodiment 3 of the present invention.

FIGS. 10A through 10F are diagrams showing an example of a method of determining whether adjacent sector IDs are consecutive, in a disk apparatus according to Embodiment 3 of the present invention.

FIG. 11 is a flow chart showing a procedure of data write processing in a DSP of a disk apparatus according to Embodiment 3 of the present invention.

FIG. 12 is a flow chart showing a procedure of data read processing in a DSP of a disk apparatus according to Embodiment 4 of the present invention.

FIG. 13 is a flow chart showing a procedure of data write processing in a DSP of a disk apparatus according to Embodiment 4 of the present invention.

### DETAILED DESCRIPTION OF THE INVENTION

In Japanese Patent Application Laid-Open No. 2002-25236 described above, it is determined whether the sector IDs of adjacent sectors are consecutive to each other. Then, when consecutive, it is determined that no off-track error has occurred. Thus, read-out data and/or written-in data are ensured as correct data. Nevertheless, since the end sector does not have such a sector that follows it, consecutiveness of sector IDs cannot be determined. Thus, when off-track error occurs at the end sector, even if the read-out data were that of another track or alternatively data were written into another track, the data is determined as if it were correct one. That is, there has been a problem that the validity of data is not ensured.

The present invention has been devised in view of this situation. An object of the present invention is to provide a disk apparatus and a method of data read and write in which even when off-track error occurs at the end sector, the occurrence of the off-track error is detected reliably, so that the transmission of read-out data to a host computer or alternatively the receiving of to-be-written data from a host computer is avoided in advance. The present invention is implemented by the following embodiments.

### Embodiment 1

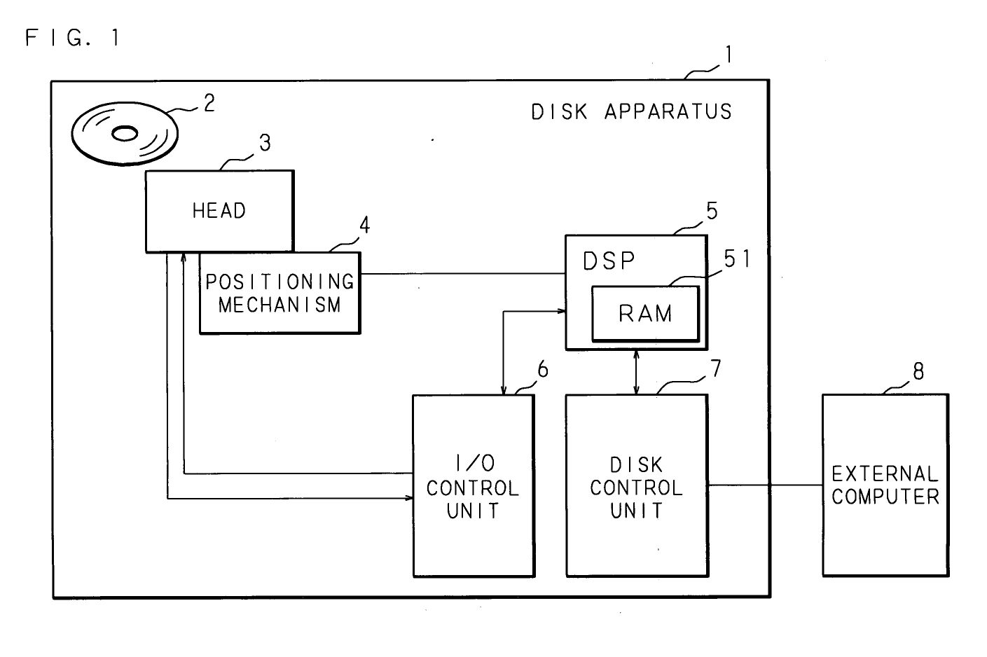

The present invention is described below in detail with reference to the drawings showing Embodiment 1. FIG. 1 is a block diagram showing the configuration of a disk apparatus according to Embodiment 1 of the present invention. The disk apparatus 1 according to the present Embodiment 1 comprises: a disk 2 serving as a storage medium; a head 3 for reading and writing data from and to the disk 2; and a positioning mechanism 4 for positioning the head 3. In response to a command issued by a disk control unit 7 in accordance with an instruction signal provided from an external computer 8, a DSP 5 controls the operation of the positioning mechanism 4. The DSP 5 transmits data read by the head 3 to the external computer 8 via an I/O control unit 6, and writes data received from the external computer 8 into the disk 2 through the head 3 via the I/O control unit 6.

For the convenience of description, one head 3, one head positioning mechanism 4, and one disk 2 are shown in FIG. 1. However, a plurality of heads 3, 3, . . . , a plurality of head positioning mechanisms 4, 4, . . . , and a plurality of disks 2, 2, . . . may be provided in actual configuration. The head 3, the head positioning mechanism 4, and the disk 2 themselves may be composed of publicly known ones. Thus, their detailed description is omitted.

When receiving a data write instruction signal from the external computer 8, the disk control unit 7 transmits, to the DSP 5, information related to a sector range into which data is to be written. The DSP 5 determines whether off-track error has occurred within the informed sector range. Then, when it is determined as not having occurred, the DSP 5 transmits an actuating signal to the positioning mechanism 4 so as to position the head 3, then receives to-be-written data via the disk control unit 7, and then writes the data into the disk 2 through the head 3 via the I/O control unit 6.

When receiving a data read instruction signal from the external computer 8, the disk control unit 7 transmits, to the DSP 5, information related to a sector range from which data is to be read. The DSP 5 determines whether off-track error has occurred within the informed sector range. Then, when it is determined as not having occurred, the DSP 5 transmits an actuating signal to the positioning mechanism 4 so as to position the head 3, and then reads the data of the disk 2 via the I/O control unit 6.

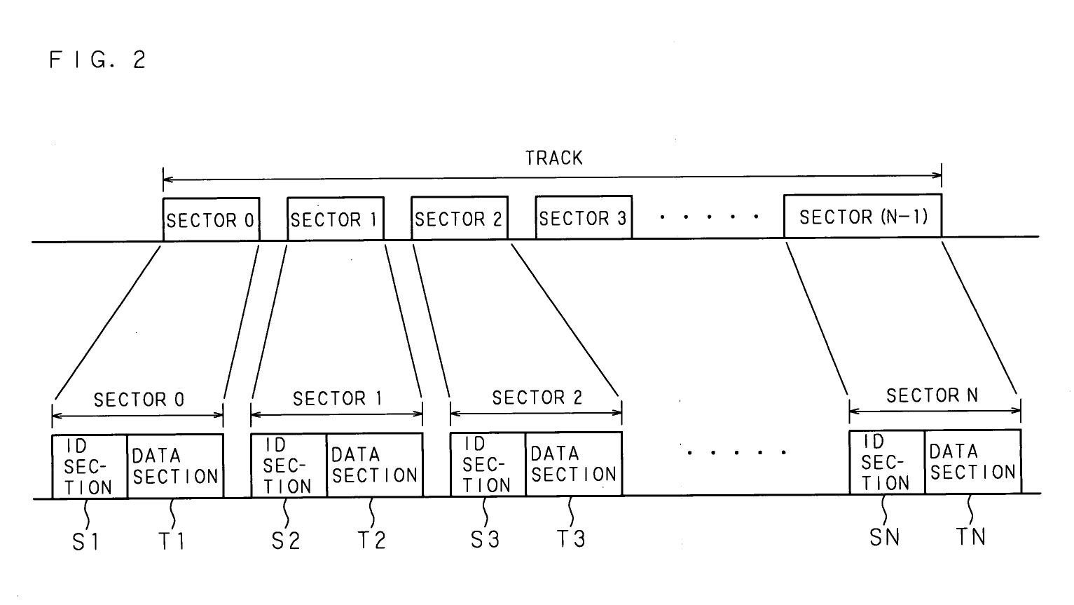

FIG. 2 is an illustrative diagram showing the sector configuration of the disk 2. The data to be read and/or written through the header 3 is stored in data sections T1, T2, . . . , TN (N is a natural number) on each sector. Further, as for sector IDs serving as information that identifies the sectors, consecutive numbers S1, S2, . . . , SN (N is a natural number) are assigned to N sectors ranging from sector 0 to sector (N−1). For example, addresses are assigned like S1=‘0001’ and S2=‘0002’, and the like. Thus, when no off-track error has occurred, the sector IDs are composed of consecutive numbers. In contrast, when off-track error occurs, this consecutiveness is broken in the sector IDs.

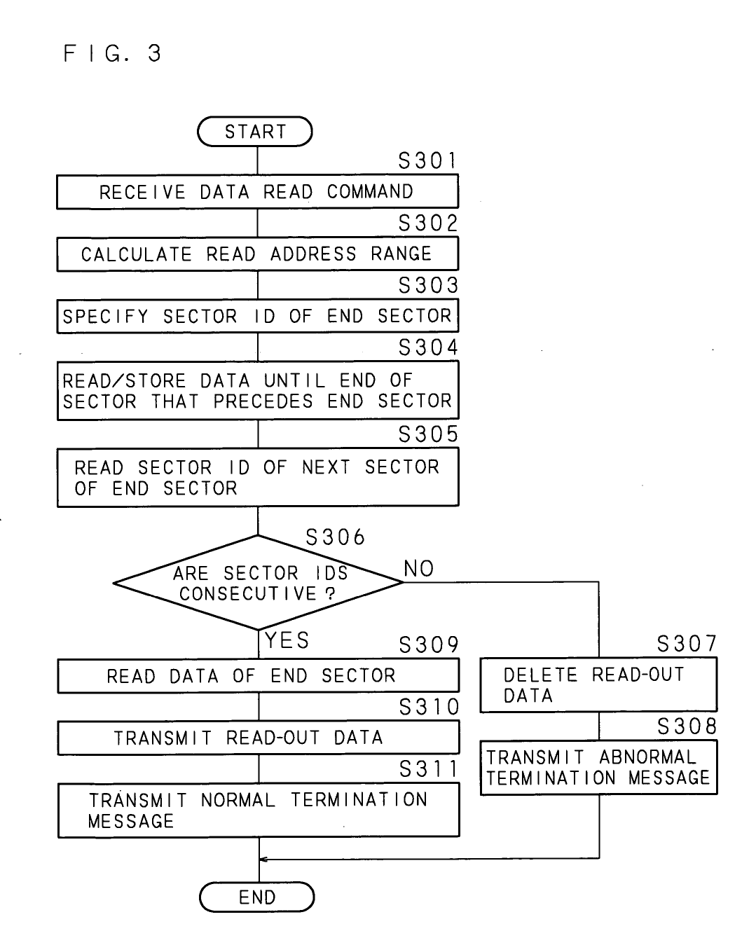

FIG. 3 is a flow chart showing a procedure of data read processing in the DSP 5 of the disk apparatus according to Embodiment 1 of the present invention. The DSP 5 receives a data read command from the external computer 8 (step S301), then calculates a read address range (step S302), and thereby specifies the identification number (such as the sector ID) of the end sector (step S303). Then, the DSP 5 executes data read by a prior art method until the end of a sector that precedes the end sector (step S304). Here, as for the sector ID of the end sector, the sector ID of a sector located at the end position within the read address range is extracted, and then the read-out data is temporarily stored into a RAM 51 built in the DSP 5.

The DSP 5 reads the sector ID of the next sector that follows the specified end sector (step S305), and then determines whether the sector ID is consecutive to the sector ID of the end sector (step S306). That is, the presence or absence of consecutiveness is determined in the numerals of the sector IDs.

When the DSP 5 determines that the sector IDs are not consecutive to each other (step S306: NO), the DSP 5 determines that off-track error has occurred at the end sector, then deletes the read-out data stored in the RAM 51 of the DSP 5, and thereby does not execute data transmission to the external computer 8 (step S307). Then, the DSP 5 transmits information indicating the situation of abnormal termination (such as an error message) to the external computer 8 (step S308). When the DSP 5 determines that the sector IDs are consecutive to each other (step S306: YES), the DSP 5 reads the data of the end sector (step S309), and then transmits the read-out data of the end sector to the external computer 8 (step S310). Then, the DSP 5 transmits information indicating the situation of normal termination (such as a normal termination message) to the external computer 8 (step S311), and then completes the processing.

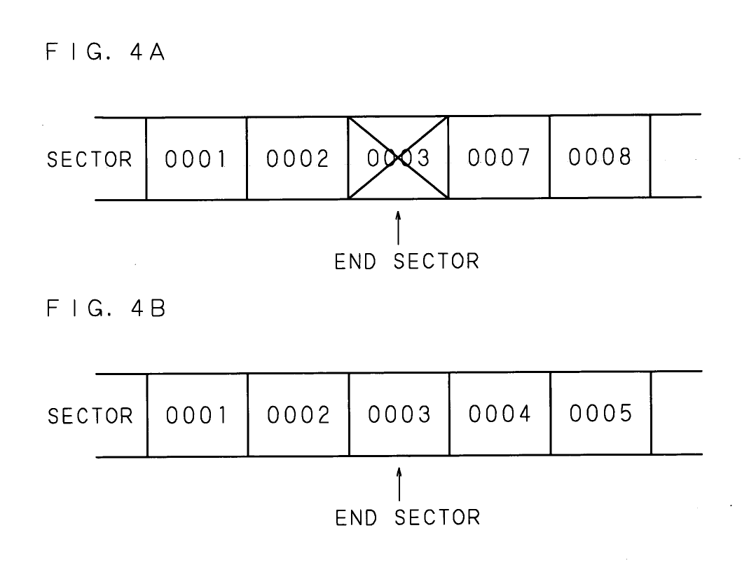

FIGS. 4A and 4B are illustrative diagrams showing sector IDs that are read when off-track error has occurred (corresponding to FIG. 4A) and when no off-track error has occurred (corresponding to FIG. 4B). In a case that the sector ID of the end sector is ‘0003’, when no off-track error has occurred at the end sector, the sector IDs of the subsequent sectors are consecutive numbers, that is, ‘0004’, ‘0005’, . . . as shown in FIG. 4B. In this case, in general, the sector of ID ‘0004’ stores data that need not be read. Data read is performed until the end of the end sector. That is, in the example of FIG. 2, the data pieces T1, T2, and T3 are read.

On the other hand, when off-track error occurs at the end sector, as shown in FIG. 4A, the sector IDs of the subsequent sectors become ‘0007’, ‘0008’, and . . . , that is, inconsecutive. Thus, at the time point when the sector ID of the end sector is extracted, the DSP 5 extracts the sector ID of the subsequent sector, and then checks whether the sector ID is consecutive to the sector ID of the end sector. As such, the DSP 5 can easily determine whether off-track error has occurred at the end sector.

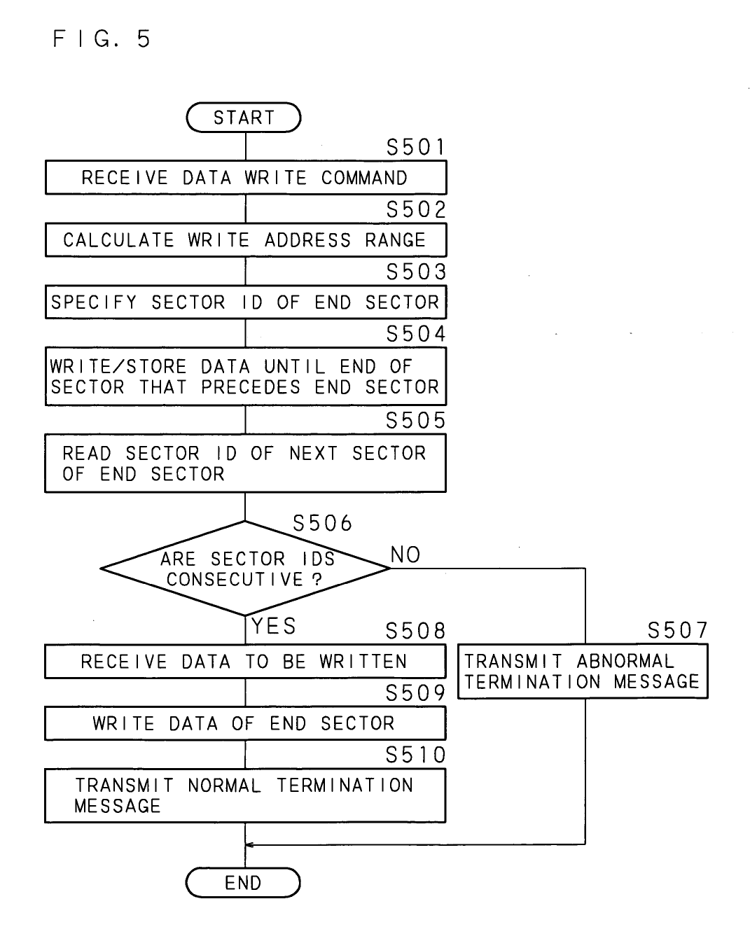

Data write processing is performed by a similar procedure. FIG. 5 is a flow chart showing a procedure of data write processing in the DSP 5 of the disk apparatus according to Embodiment 1 of the present invention. The DSP 5 receives a data write command from the external computer 8 (step S501), then calculates a write address range (step S502), and thereby specifies the identification number (such as the sector ID) of the end sector (step S503). The DSP 5 executes data write by a prior art method until the end of a sector that precedes the end sector (step S504). Here, as for the sector ID of the end sector, the sector ID of a sector located at the end position within the write address range is extracted, and then to-be-written data received from the external computer 8 is temporarily stored into the RAM 51 built in the DSP 5.

The DSP 5 reads the sector ID of the next sector that follows the specified end sector (step S505), and then determines whether the sector ID is consecutive to the sector ID of the end sector (step S506). That is, the presence or absence of consecutiveness is determined in the numerals of the sector IDs.

When the DSP 5 determines that the sector IDs are not consecutive to each other (step S506: NO), the DSP 5 determines that off-track error has occurred at the end sector, and thereby transmits information indicating the situation of abnormal termination (such as an error message) to the external computer 8 (step S507). When the DSP 5 determines that the sector IDs are consecutive to each other (step S506: YES), the DSP 5 receives data to be written into the end sector, from the external computer 8 (step S508), and then writes the data into the end sector (step S509). Then, the DSP 5 transmits information indicating the situation of normal termination (such as a normal termination message) to the external computer 8 (step S510), and then completes the processing.

As described above, according to the present Embodiment 1, a fact is detected that the sector IDs are not consecutive to each other when off-track error has occurred. This permits reliable detection of the occurrence of off-track error at the end sector which has been undetectable in the prior art. Thus, when off-track error has occurred, read-out data is prevented from being transmitted to the external computer 8 or alternatively to-be-written data is prevented from being received from the external computer 8. Accordingly, only when no off-track error has occurred, read-out data is transmitted to the external computer 8 or alternatively to-be-written data is received from the external computer 8. This ensures the validity of the read-out data and/or the written-in data.

### Embodiment 2

The present invention is described below in detail with reference to the drawings showing Embodiment 2. The configuration of the disk apparatus according to Embodiment 2 of the present invention is similar to that of Embodiment 1. Thus, like numerals are employed so that detailed description is omitted.

The disk apparatus 1 according to the present Embodiment 2 is different from that of Embodiment 1 in the point that no special processing is performed on the end sector. That is, the next sector that follows the end sector is tentatively considered as the end sector, and then the same processing as the prior art is performed so that consecutiveness is detected in the sector IDs.

Here, for the convenience of description, a plurality of heads 3, 3, . . . , a plurality of head positioning mechanisms 4, 4, . . . , and a plurality of disks 2, 2, . . . may be provided similarly to Embodiment 1. The head 3, the head positioning mechanism 4, and the disk 2 themselves may be composed of publicly known ones. Thus, their detailed description is omitted.

When receiving a data write instruction signal from the external computer 8, the disk control unit 7 transmits, to the DSP 5, information related to a sector range into which data is to be written. The DSP 5 determines whether off-track error has occurred within the informed sector range. Then, when it is determined as not having occurred, the DSP 5 transmits an actuating signal to the positioning mechanism 4 so as to position the head 3, then receives to-be-written data via the disk control unit 7, and then writes the data into the disk 2 through the head 3 via the I/O control unit 6.

When receiving a data read instruction signal from the external computer 8, the disk control unit 7 transmits, to the DSP 5, information related to a sector range from which data is to be read. The DSP 5 determines whether off-track error has occurred within the informed sector range. Then, when it is determined as not having occurred, the DSP 5 transmits an actuating signal to the positioning mechanism 4 so as to position the head 3, and then reads the data of the disk 2 via the I/O control unit 6.

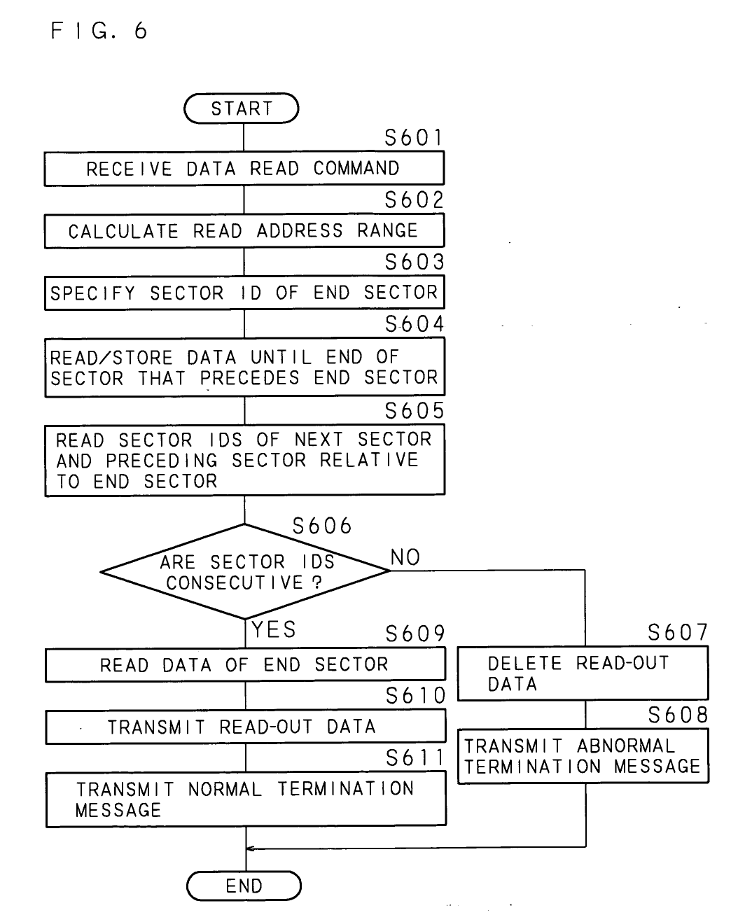

FIG. 6 is a flow chart showing a procedure of data read processing in the DSP 5 of the disk apparatus according to Embodiment 2 of the present invention. The DSP 5 receives a data read command from the external computer 8 (step S601), then calculates a read address range (step S602), and thereby specifies the identification number (such as the sector ID) of the end sector (step S603). Then, the DSP 5 executes data read by a prior art method until the end of a sector that precedes the end sector (step S604). Here, as for the sector ID of the end sector, the sector ID of a sector located at the end position within the read address range is extracted, and then the read-out data is temporarily stored into the RAM 51 built in the DSP 5.

The DSP 5 reads the sector IDs of the next sector that follows the specified end sector and the sector that precedes the end sector (step S605), and then determines whether these sector IDs are consecutive to the sector ID of the end sector (step S606). That is, the presence or absence of consecutiveness is determined in the numerals of the sector IDs of the end sector and its two adjacent sectors. When off-track error has occurred immediately before the reading of the end sector, the numerals of the sector IDs are consecutive between the end sector and the next sector that follows it. Thus, the method of Embodiment 1 cannot detect the off-track error. However, in this case, the numerals of the sector IDs are inconsecutive between the end sector and the preceding sector. Thus, when it is checked whether the numerals of the sector IDs are consecutive between the end sector and the preceding sector, the occurrence of off-track error is detected even in a case that off-track error has occurred immediately before the reading of the end sector.

When the DSP 5 determines that the sector IDs are not consecutive to each other (step S606: NO), the DSP 5 determines that off-track error has occurred at the end sector, then deletes the read-out data stored in the RAM 51 of the DSP 5, and thereby does not execute data transmission to the external computer 8 (step S607). Then, the DSP 5 transmits information indicating the situation of abnormal termination (such as an error message) to the external computer 8 (step S608). When the DSP 5 determines that the sector IDs are consecutive to each other (step S606: YES), the DSP 5 reads the data of the end sector (step S609), and then transmits the read-out data of the end sector to the external computer 8 (step S610). Then, the DSP 5 transmits information indicating the situation of normal termination (such as a normal termination message) to the external computer 8 (step S611), and then completes the processing.

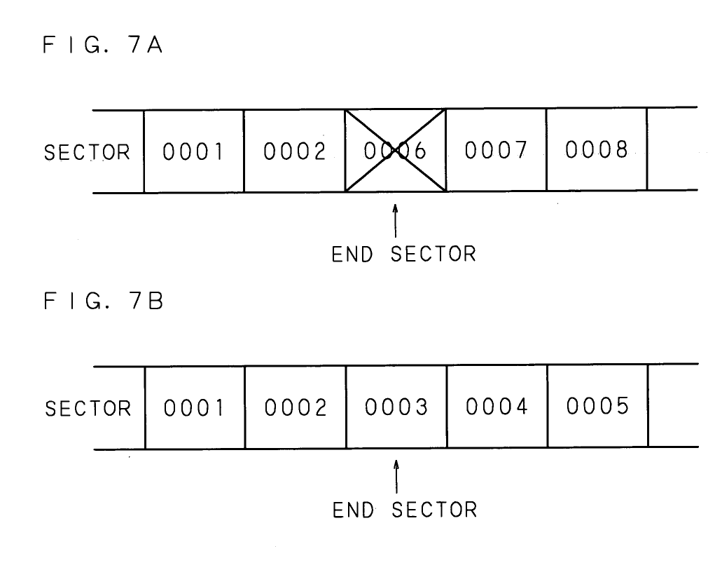

FIGS. 7A and 7B are illustrative diagrams showing sector IDs that are read when off-track error has occurred (corresponding to FIG. 7A) and when no off-track error has occurred (corresponding to FIG. 7B). In a case that the sector ID of the end sector is ‘0003’, when no off-track error has occurred at the end sector, the sector IDs of the subsequent sectors are consecutive numbers, that is, ‘0004’, ‘0005’, . . . as shown in FIG. 7B. In this case, in general, the sector of ID ‘0004’ stores data that need not be read. Data read is performed until the end of the end sector. That is, in the example of FIG. 2, the data pieces T1, T2, and T3 are read.

On the other hand, when off-track error has occurred immediately before the reading of the end sector, the sector ID of the end sector becomes ‘0006’ as shown in FIG. 7A, which is not consecutive to the sector ID of the preceding sector. However, the sector ID is consecutive to the sector IDs ‘0007’, ‘0008’, . . . of the subsequent sectors. Thus, at the time point when the sector ID of the end sector is extracted, the DSP 5 extracts the sector ID of the subsequent sector and the sector ID of the preceding sector, and then checks whether these sector IDs are consecutive to the sector ID of the end sector. By virtue of this, even when off-track error has occurred at the end sector at any timing, the DSP 5 can reliably detect the occurrence.

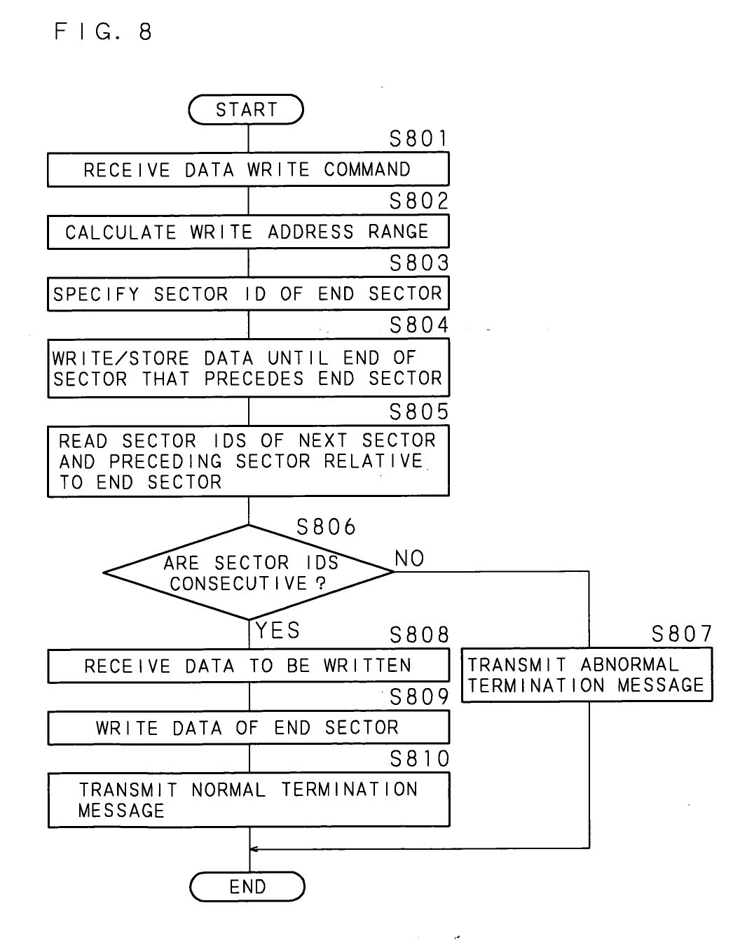

Data write processing is performed by a similar procedure. FIG. 8 is a flow chart showing a procedure of data write processing in a DSP of a disk apparatus according to Embodiment 2 of the present invention. The DSP 5 receives a data write command from the external computer 8 (step S801), then calculates a write address range (step S802), and thereby specifies the identification number (such as the sector ID) of the end sector (step S803). The DSP 5 executes data write by a prior art method until the end of a sector that precedes the end sector (step S804). Here, as for the sector ID of the end sector, the sector ID of a sector located at the end position within the write address range is extracted, and then to-be-written data received from the external computer 8 is temporarily stored into the RAM 51 built in the DSP 5.

The DSP 5 reads the sector IDs of the next sector that follows the specified end sector and the sector that precedes the end sector (step S805), and then determines whether these sector IDs are consecutive to the sector ID of the end sector (step S806). That is, the presence or absence of consecutiveness is determined in the numerals of the sector IDs of the end sector and its two adjacent sectors. When off-track error has occurred immediately before the reading of the end sector, the numerals of the sector IDs are consecutive between the end sector and the next sector that follows it. Thus, the method of Embodiment 1 cannot detect the off-track error. However, in this case, the numerals of the sector IDs are inconsecutive between the end sector and the preceding sector. Thus, when it is checked whether the numerals of the sector IDs are consecutive between the end sector and the preceding sector, the occurrence of off-track error is detected even in a case that off-track error has occurred immediately before the reading of the end sector.

When the DSP 5 determines that the sector IDs are not consecutive to each other (step S806: NO), the DSP 5 determines that off-track error has occurred at the end sector, and thereby transmits information indicating the situation of abnormal termination (such as an error message) to the external computer 8 (step S807). When the DSP 5 determines that the sector IDs are consecutive to each other (step S806: YES), the DSP 5 receives data to be written into the end sector, from the external computer 8 (step S808), and then writes the data into the end sector (step S809). Then, the DSP 5 transmits information indicating the situation of normal termination (such as a normal termination message) to the external computer 8 (step S810), and then completes the processing.

As described above, according to the present Embodiment 2, even in a case that off-track error has occurred immediately before the reading of the end sector and that still the data has been tried to be read out intact, or alternatively in a case that data has been tried to be written in intact, the occurrence of the off-track error is detected reliably since consecutiveness is not achieved with the identification number of the preceding sector. Thus, even when off-track error occurs at any timing, read-out data is not output or alternatively to-be-written data is not received from the outside. This ensures the validity of the read-out data and/or the written-in data.

### Embodiment 3

The present invention is described below in detail with reference to the drawings showing Embodiment 3. The configuration of the disk apparatus according to Embodiment 3 of the present invention is similar to that of Embodiment 1. Thus, like numerals are employed so that detailed description is omitted. The disk apparatus 1 according to the present Embodiment 3 is different from that of Embodiment 1 in the point that consecutiveness of sector IDs is detected also between the end sector and a sector that precedes the end sector in order that such a case should appropriately be handled that off-track error occurs immediately before the reading of the end sector.

Here, although simplified into singular for the convenience of description, a plurality of heads 3, 3, . . . , a plurality of head positioning mechanisms 4, 4, . . . , and a plurality of disks 2, 2, . . . may be provided similarly to Embodiment 1. The head 3, the head positioning mechanism 4, and the disk 2 themselves may be composed of publicly known ones. Thus, their detailed description is omitted.

When receiving a data write instruction signal from the external computer 8, the disk control unit 7 transmits, to the DSP 5, information related to a sector range into which data is to be written. The DSP 5 determines whether off-track error has occurred within the informed sector range. Then, when it is determined as not having occurred, the DSP 5 transmits an actuating signal to the positioning mechanism 4 so as to position the head 3, then receives to-be-written data via the disk control unit 7, and then writes the data into the disk 2 through the head 3 via the I/O control unit 6.

When receiving a data read instruction signal from the external computer 8, the disk control unit 7 transmits, to the DSP 5, information related to a sector range from which data is to be read. The DSP 5 determines whether off-track error has occurred within the informed sector range. Then, when it is determined as not having occurred, the DSP 5 transmits an actuating signal to the positioning mechanism 4 so as to position the head 3, and then reads the data of the disk 2 via the I/O control unit 6.

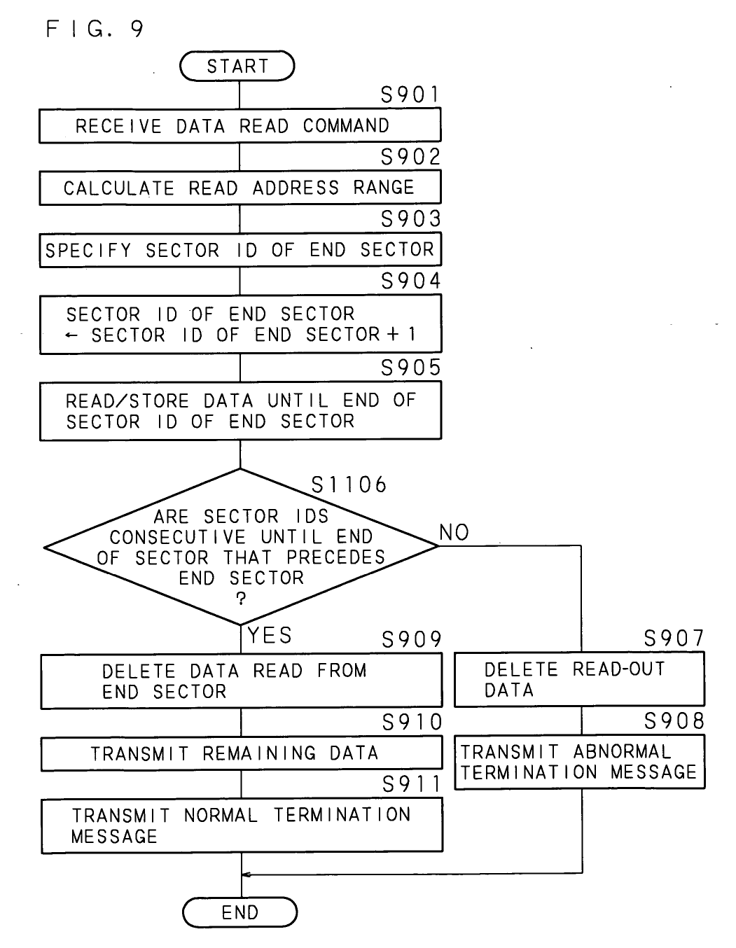

FIG. 9 is a flow chart showing a procedure of data read processing in the DSP 5 of the disk apparatus according to Embodiment 3 of the present invention. The DSP 5 receives a data read command from the external computer 8 (step S901), then calculates a read address range (step S902), and thereby specifies the identification number (such as the sector ID) of the end sector (step S903). Here, as for the sector ID of the end sector, the sector ID of a sector located at the end position within the read address range is extracted.

The DSP 5 increments by unity the sector ID of the specified end sector so as to adopt the sector ID as that of a new end sector (step S904). Then, the DSP 5 executes data read by a prior art method until the end of the sector ID of the new end sector (step S905). The read-out data is temporarily stored into the RAM 51 built in the DSP 5. The DSP 5 determines whether the sector IDs are consecutive to each other until the end of the sector ID that precedes the sector ID of the new end sector, that is, until the end of the intrinsic end sector (step S906).

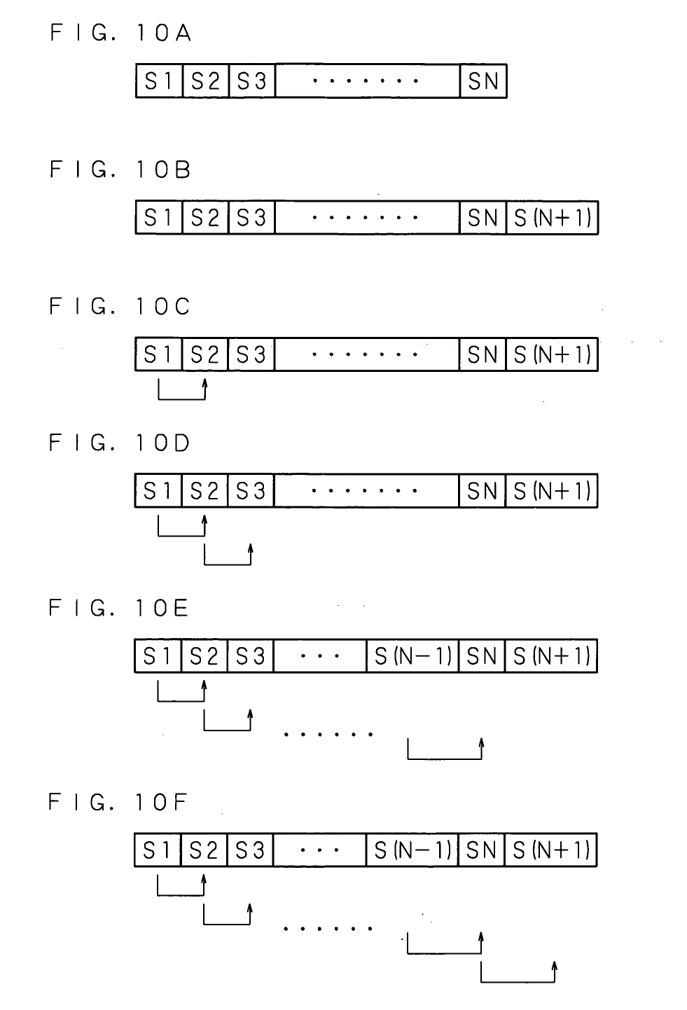

Here, the employed method of determining whether the sector IDs are consecutive to each other is not limited to a specific determination method in the prior art. FIGS. 10A through 10F are diagrams showing an example of a method of determining whether adjacent sector IDs are consecutive, in the disk apparatus according to Embodiment 3 of the present invention. The processing described later is referred to as retry read processing for off-track error or alternatively off-track retry.

That is, as shown in FIG. 10A, when the DSP 5 receives a read command for an address range containing N sector IDs (N is a natural number), the sector IDs are S1, S2, . . . , SN. Thus, the DSP 5 can identify SN as the sector ID of the end sector. In the present Embodiment [?2?] 3, the DSP 5 adopts the value S(N+1) generated by incrementing the value SN by unity, as the sector ID of the new end sector (see FIG. 10B), and then determines whether the adjacent sector IDs are consecutive.

First, as shown in FIG. 10C, the DSP 5 determines whether the sector ID of a sector located at the beginning of the read addresses and the sector ID of the next sector, that is, S1 and S2, are consecutive to each other. When determined as consecutive, the DSP 5 then determines whether S2 and S3 are consecutive to each other, as shown in FIG. 10D. Then, the DSP 5 continues to determine whether successively adjacent sector IDs are consecutive to each other.

In the determination whether the adjacent sector IDs are consecutive to each other, in the prior art determination method, determination of the consecutiveness of the sector IDs is achievable merely until the determination between the sector that precedes the end sector and the end sector, that is, between S(N−1) and SN, as shown in FIG. 10E. Accordingly, off-track error at SN is undetectable, if occurred. In contrast, in the present Embodiment [?2?] 3, the value S(N+1) generated by incrementing SN by unity is adopted as the sector ID of a new end sector, and then it is determined whether the adjacent sector IDs are consecutive to each other. Thus, as shown in FIG. 10F, when it is determined whether the sector ID of the intrinsic end sector and the sector ID of the next sector that follows it, that is, SN and S(N+1), are consecutive to each other, it is easily determined whether off-track error has occurred at the end sector.

When the DSP 5 determines that the sector IDs are not consecutive to each other (step S906: NO), the DSP 5 determines that off-track error has occurred, then deletes the read-out data stored in the RAM 51 of the DSP 5, and thereby does not execute data transmission to the external computer 8 (step S907). Then, the DSP 5 transmits information indicating the situation of abnormal termination (such as an error message) to the external computer 8 (step S908).

When the DSP 5 determines that the sector IDs are consecutive to each other (step S906: YES), the DSP 5 deletes the data read from the new end sector and stored in the RAM 51 (step S909), and then transmits to the external computer 8 the data read from the end sector (step S910). Then, the DSP 5 transmits information indicating the situation of normal termination (such as a normal termination message) to the external computer 8 (step S911), and then completes the processing.

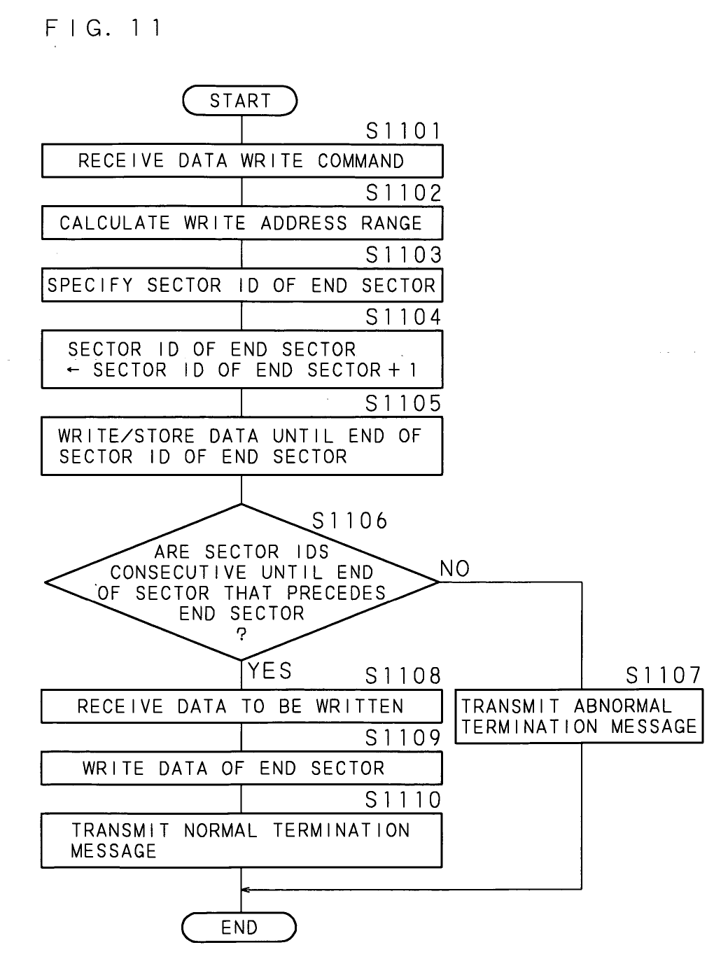

Data write processing is performed by a similar procedure. FIG. 11 is a flow chart showing a procedure of data write processing in the DSP 5 of the disk apparatus according to Embodiment 3 of the present invention. The DSP 5 receives a data write command from the external computer 8 (step S1101), then calculates a write address range (step S1102), and thereby specifies the identification number (such as the sector ID) of the end sector (step S1103). Here, as for the sector ID of the end sector, the sector ID of a sector located at the end position within the read address range is extracted.

The DSP 5 increments by unity the sector ID of the specified end sector so as to adopt the sector ID as that of a new end sector (step S1104). Then, the DSP 5 executes data write by a prior art method until the end of the sector ID of the new end sector (step S1105). To-be-written data received from the external computer 8 is temporarily stored into the RAM 51 built in the DSP 5. The DSP 5 determines whether the sector IDs are consecutive to each other until the end of the sector ID that precedes the sector ID of the new end sector, that is, until the end of the intrinsic end sector (step S1106). Here, the employed method of determining whether the sector IDs are consecutive to each other is not limited to a specific determination method in the prior art.

When the DSP 5 determines that the sector IDs are not consecutive to each other (step S1106: NO), the DSP 5 determines that off-track error has occurred, and thereby transmits information indicating the situation of abnormal termination (such as an error message) to the external computer 8 (step S1107). When the DSP 5 determines that the sector IDs are consecutive to each other (step S1106: YES), the DSP 5 receives data to be written into the end sector, from the external computer 8 (step S1108), and then writes the data into the end sector (step S1109). Then, the DSP 5 transmits information indicating the situation of normal termination (such as a normal termination message) to the external computer 8 (step S1110), and then completes the processing.

As described above, according to the present Embodiment 3, when a sector that follows the end sector and that stores no data to be read is tentatively considered as the end sector, a method similar to the prior art can easily determine whether off-track error has occurred at the intrinsic end sector. Further, when no off-track error has occurred, data transmission is performed with excluding the data of the portion having been considered as the new end sector. This realizes the reading of correct data the validity of which is ensured.

### Embodiment 4

The present invention is described below in detail with reference to the drawings showing Embodiment 4. The configuration of the disk apparatus according to Embodiment 4 of the present invention is similar to that of Embodiments 1 and 2. Thus, like numerals are employed so that detailed description is omitted. The disk apparatus 1 according to the present Embodiment 4 is different from that of Embodiment 1 in the point that whether off-track retry has been generated is determined in Embodiment 2, so that the amount of execution of determination processing whether the sector IDs are consecutive to each other is reduced remarkably.

Here, although simplified into singular for the convenience of description, a plurality of heads 3, 3, . . . , a plurality of head positioning mechanisms 4, 4, . . . , and a plurality of disks 2, 2, . . . may be provided similarly to Embodiments 1 and 2. The head 3, the head positioning mechanism 4, and the disk 2 themselves may be composed of publicly known ones. Thus, their detailed description is omitted.

When receiving a data write instruction signal from the external computer 8, the disk control unit 7 transmits, to the DSP 5, information related to a sector range into which data is to be written. The DSP 5 determines whether off-track error has occurred within the informed sector range. Then, when it is determined as not having occurred, the DSP 5 transmits an actuating signal to the positioning mechanism 4 so as to position the head 3, then receives to-be-written data via the disk control unit 7, and then writes the data into the disk 2 through the head 3 via the I/O control unit 6.

When receiving a data read instruction signal from the external computer 8, the disk control unit 7 transmits, to the DSP 5, information related to a sector range from which data is to be read. The DSP 5 determines whether off-track error has occurred within the informed sector range. Then, when it is determined as not having occurred, the DSP 5 transmits an actuating signal to the positioning mechanism 4 so as to position the head 3, and then reads the data of the disk 2 via the I/O control unit 6.

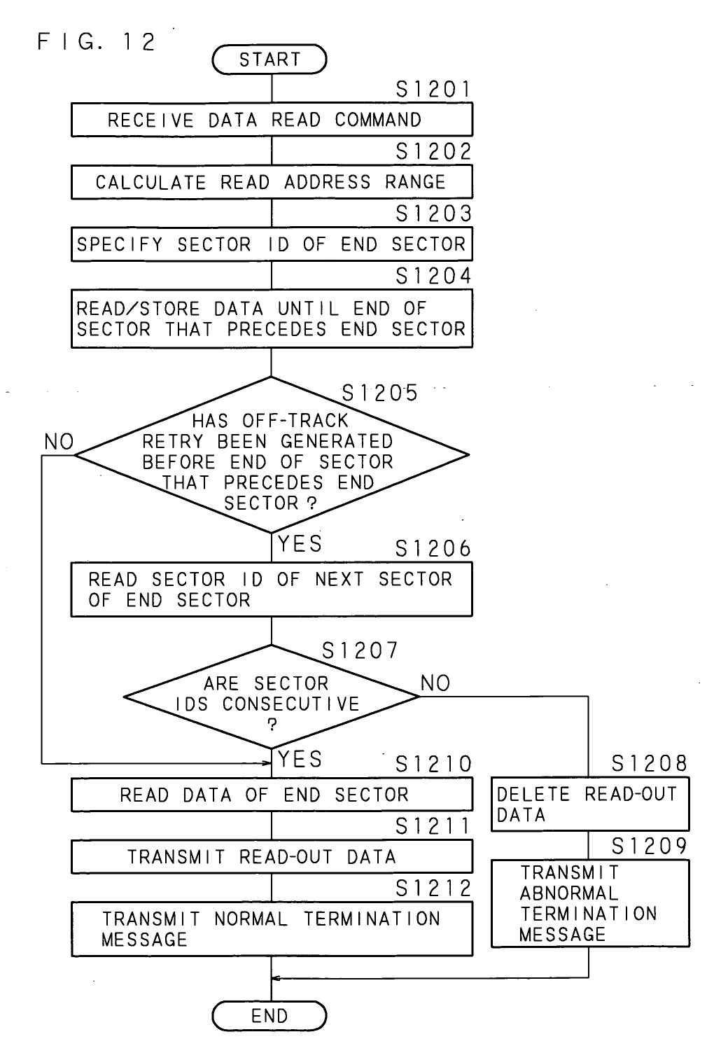

FIG. 12 is a flow chart showing a procedure of data read processing in the DSP 5 of the disk apparatus according to Embodiment 4 of the present invention. The DSP 5 receives a data read command from the external computer 8 (step S1201), then calculates a read address range (step S1202), and thereby specifies the identification number (such as the sector ID) of the end sector (step S1203). Then, the DSP 5 executes data read by a prior art method until the end of a sector that precedes the end sector (step (step S1204). Here, as for the sector ID of the end sector, the sector ID of a sector located at the end position within the read address range is extracted, and then the read-out data is temporarily stored into the RAM 51 built in the DSP 5.

The DSP 5 determines whether off-track retry has been generated before the end of a sector that precedes the end sector (step S1205). Specifically, the DSP 5 stores, into the built-in RAM 51, information related to sector IDs where off-track error has occurred and the number of times of occurrence of off-track error. Then, at each time of occurrence of off-track error, the DSP 5 increments the counter for the sector ID where the off-track error has occurred. Thus, when referring to the RAM 51, the DSP 5 can determine whether off-track error has occurred before the end of the sector that precedes the end sector, that is, whether off-track retry has been generated as error handling.

When the DSP 5 determines that off-track retry has been generated (step S1205: YES), the DSP 5 reads the sector ID of the next sector that follows the specified end sector (step S1206), and then determines whether the sector ID is consecutive to the sector ID of the end sector (step S1207). That is, the presence or absence of consecutiveness is determined in the numerals of the sector IDs.

When the DSP 5 determines that the sector IDs are not consecutive to each other (step S1207: NO), the DSP 5 determines that off-track error has occurred at the end sector, then deletes the read-out data stored in the RAM 51 of the DSP 5, and thereby does not execute data transmission to the external computer 8 (step S1208). Then, the DSP 5 transmits information indicating the situation of abnormal termination (such as an error message) to the external computer 8 (step S1209). When the DSP 5 determines that the sector IDs are consecutive to each other (step S1207: YES) or alternatively when the DSP 5 determines that no off-track retry has been generated (step S1205: NO), the DSP 5 reads the data of the end sector (step S1210), and then transmits to the external computer 8 the data read from the end sector (step S1211). Then, the DSP 5 transmits information indicating the situation of normal termination (such as a normal termination message) to the external computer 8 (step S1212), and then completes the processing.

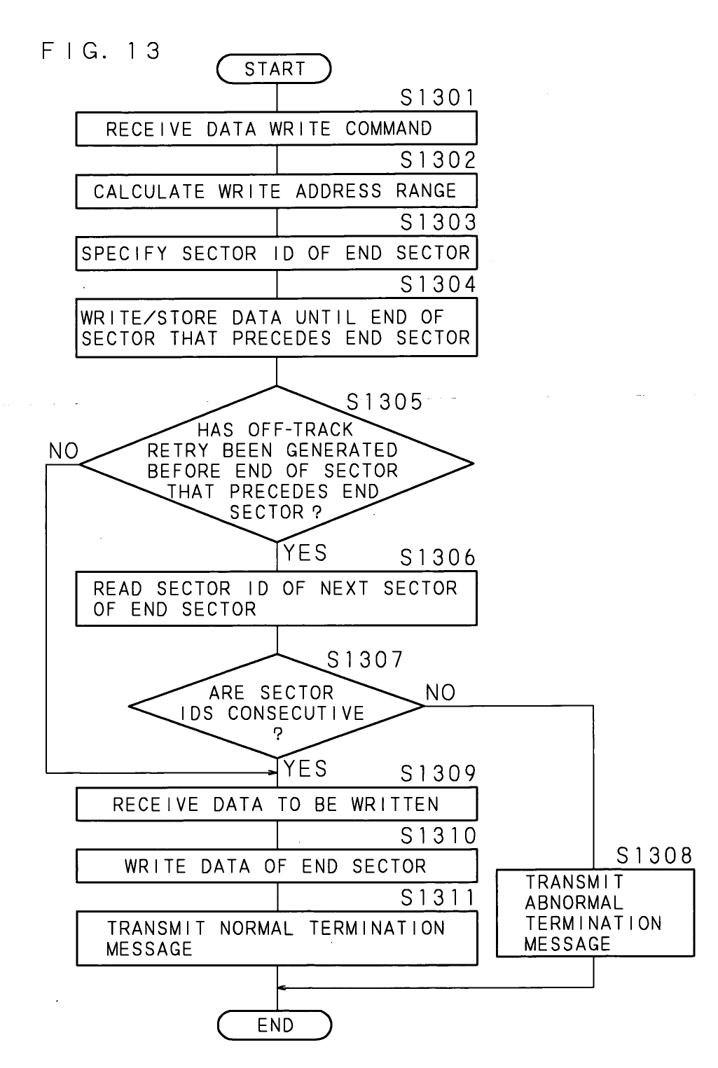

Data write processing is performed by a similar procedure. FIG. 13 is a flow chart showing a procedure of data write processing in the DSP 5 of the disk apparatus according to Embodiment 4 of the present invention. The DSP 5 receives a data write command from the external computer 8 (step S1301), then calculates a write address range (step S1302), and thereby specifies the identification number (such as the sector ID) of the end sector (step S1303). The DSP 5 executes data write by a prior art method until the end of a sector that precedes the end sector (step S1304). Here, as for the sector ID of the end sector, the sector ID of a sector located at the end position within the write address range is extracted, and then to-be-written data received from the external computer 8 is temporarily stored into the RAM 51 built in the DSP 5.

The DSP 5 determines whether off-track retry has been generated before the end of a sector that precedes the end sector (step S1305). Specifically, the DSP 5 stores, into the built-in RAM 51, information related to sector IDs where off-track error has occurred and the number of times of occurrence of off-track error. Then, at each time of occurrence of off-track error, the DSP 5 increments the counter for the sector ID where the off-track error has occurred. Thus, when referring to the RAM 51, the DSP 5 can determine whether off-track error has occurred before the end of the sector that precedes the end sector, that is, whether off-track retry has been generated as error handling.

When the DSP 5 determines that off-track retry has been generated (step S1305: YES), the DSP 5 reads the sector ID of the next sector that follows the specified end sector (step S1306), and then determines whether the sector ID is consecutive to the sector ID of the end sector (step S1307). That is, the presence or absence of consecutiveness is determined in the numerals of the sector IDs.

When the DSP 5 determines that the sector IDs are not consecutive to each other (step S1307: NO), the DSP 5 determines that off-track error has occurred at the end sector, and thereby transmits information indicating the situation of abnormal termination (such as an error message) to the external computer 8 (step S1308). When the DSP 5 determines that the sector IDs are consecutive to each other (step S1307: YES) or alternatively when the DSP 5 determines that no off-track retry has been generated (step S1305: NO), the DSP 5 receives data to be written into the end sector, from the external computer 8 (step S1309), and then writes the data into the end sector (step S1310). Then, the DSP 5 transmits information indicating the situation of normal termination (such as a normal termination message) to the external computer 8 (step S1311), and then completes the processing.

Here, as for the processing performed when the DSP 5 determines that off-track retry has been generated (step S1305: YES), the present invention is not limited to that the sector ID of the next sector that follows the specified end sector is read and that it is then determined whether the sector ID is consecutive to the sector ID of the end sector. That is, for example, similarly to Embodiment 2, the sector ID of the next sector that follows the end sector and the sector ID of the preceding sector may be read, and then the presence or absence of consecutiveness may be determined in the sector IDs of the end sector and its two adjacent sectors. In this case, even when off-track error occurs at any timing, read-out data is not output or alternatively to-be-written data is not received from the outside. This ensures the validity of the read-out data or the written-in data.

As described above, according to the present Embodiment 4, when no off-track retry has been generated, it is determined that no off-track error has occurred at any sector up to the end sector. Thus, the validity of the data is ensured without the necessity of improving the sector read processing. When off-track retry has been generated, similarly to Embodiment 1, it is sufficient to determine whether the identification number of the next sector of the end sector is consecutive to the end sector identification number. Further, similarly to Embodiment 2, it is sufficient to determine whether the identification number of the next sector and the identification number of the preceding sector relative to the end sector are consecutive to the end sector identification number. This reduces the load of arithmetic operation in the processing of determining whether the sector IDs are consecutive to each other. Thus, read-out data is output only when no off-track error has occurred, so that validity is ensured in the read-out data.

Here, in Embodiments 1 through 4 described above, a data transfer pointer indicating a sector serving as a data transfer target and a read-write pointer indicating a sector serving as a target of data read and write indicate distinct ranges. That is, the data transfer pointer indicates a range extending from the read start sector to the end sector, while the read-write pointer indicates a range extending from the read-write start sector to a predetermined sector that follows the end sector. As such, in contrast to the prior art where these two pointers indicate the same range, these pointers of the present invention indicate distinct ranges. By virtue of this, data which should not be read, for example, the data stored in a sector that follows the end sector, is prevented in advance from being output. That is, data the validity of which is ensured is solely output.

It should be noted that Embodiments 1 through 4 described above are exemplary embodiments. That is, the present invention is not limited to these specific embodiments, while various modifications and improvements can be made within the scope of the present invention.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A disk apparatus having:
a head for reading and/or writing data on each sector from or to a track on a disk; and
a head position control unit for controlling the position of the head on said disk, comprising:
means for acquiring an end sector identification number that identifies the end sector related to the read and/or write of the data;
next sector reading means for reading an identification number of the next sector of the end sector when data of the end sector corresponding to the acquired end sector identification number is read and/or written;
means for determining whether the read-out identification number of the next sector is consecutive to said end sector identification number; and
means for outputting the data read from the end sector, or alternatively receiving from the outside the data to be written into the end sector, when the preceding means has determined as consecutive.

2. A disk apparatus having:
a head for reading and/or writing data on each sector from or to a track on a disk; and
a head position control unit for controlling the position of the head on said disk, comprising:
means for acquiring an end sector identification number that identifies the end sector related to the read and/or write of the data;
adjacent sectors reading means for reading an identification number of the next sector and an identification number of the preceding sector relative to the end sector when data of the end sector corresponding to the acquired end sector identification number is read and/or written;
means for determining whether the identification number of the next sector and the identification number of the preceding sector having been read are consecutive to said end sector identification number; and
means for outputting the data read from the end sector, or alternatively receiving from the outside the data to be written into the end sector, when the preceding means has determined as consecutive.

3. A disk apparatus having:
a head for reading and/or writing data on each sector from or to a track on a disk; and
a head position control unit for controlling the position of the head on said disk, comprising:
means for acquiring an end sector identification number that identifies the end sector related to the read and/or write of the data;
means for generating a new end sector identification number by incrementing by unity the end sector identification number, when data of the end sector corresponding to the acquired end sector identification number is read and/or written;
means for determining whether the sector identification numbers up to the generated new end sector identification number are consecutive to each other; and
means for outputting the data read from the other sectors with excluding the data read from the sector corresponding to the new end sector identification number, or alternatively receiving from the outside the data to be written into the sectors other than the sector corresponding to the new end sector identification number, when the preceding means has determined as consecutive.

4. A disk apparatus according to claim 1, further comprising
means for determining whether off-track retry has been generated before the end of a sector located at a position generated by decrementing by unity the acquired end sector identification number, wherein
only when the means has determined that off-track retry has been generated, said next sector reading means reads the identification number of the next sector of said end sector.

5. A disk apparatus according to claim 2, further comprising
means for determining whether off-track retry has been generated before the end of a sector located at a position generated by decrementing by unity the acquired end sector identification number, wherein
only when the means has determined that off-track retry has been generated, said adjacent sectors reading means reads the identification number of the next sector and the identification number of the preceding sector relative to said end sector.

6. A disk apparatus having:
a head for reading and/or writing data on each sector from or to a track on a disk; and
a head position control unit for controlling the position of the head on said disk, comprising a processor capable of performing the steps of:
acquiring an end sector identification number that identifies the end sector related to the read and/or write of the data;
reading an identification number of the next sector of the end sector when data of the end sector corresponding to the acquired end sector identification number is read and/or written;
determining whether the read-out identification number of the next sector is consecutive to said end sector identification number; and
outputting the data read from the end sector, or alternatively receiving from the outside the data to be written into the end sector, when determined as consecutive.

7. A disk apparatus having:
a head for reading and/or writing data on each sector from or to a track on a disk; and
a head position control unit for controlling the position of the head on said disk, comprising a processor capable of performing the steps of
acquiring an end sector identification number that identifies the end sector related to the read and/or write of the data;
reading an identification number of the next sector and an identification number of the preceding sector relative to the end sector when data of the end sector corresponding to the acquired end sector identification number is read and/or written;
determining whether the identification number of the next sector and the identification number of the preceding sector having been read are consecutive to said end sector identification number; and
outputting the data read from the end sector, or alternatively receiving from the outside the data to be written into the end sector, when determined as consecutive.

8. A disk apparatus having:
a head for reading and/or writing data on each sector from and/or to a track on a disk; and
a head position control unit for controlling the position of the head on said disk, comprising a processor capable of performing the steps of:
acquiring an end sector identification number that identifies the end sector related to the read and/or write of the data;
generating a new end sector identification number by incrementing by unity the end sector identification number, when data of the end sector corresponding to the acquired end sector identification number is read and/or written;
determining whether the sector identification numbers up to the generated new end sector identification number are consecutive to each other; and
outputting the data read from the other sectors with excluding the data read from the sector corresponding to the new end sector identification number, or alternatively receiving from the outside the data to be written into the sectors other than the sector corresponding to the new end sector identification number, when determined as consecutive.

9. A disk apparatus according to claim 6, comprising the processor further capable of performing the steps of
determining whether off-track retry has been generated before the end of a sector located at a position generated by decrementing by unity the acquired end sector identification number; and
reading the identification number of the next sector of said end sector only when determined that off-track retry has been generated.

10. A disk apparatus according to claim 7, comprising the processor further capable of performing the steps of:
determining whether off-track retry has been generated before the end of a sector located at a position generated by decrementing by unity the acquired end sector identification number; and
reading the identification number of the next sector and the identification number of the preceding sector relative to said end sector only when determined that off-track retry has been generated.

11. A method of data read and write using a disk apparatus wherein data is read from and/or written into a track on a disk on each sector, comprising the steps of:
acquiring an end sector identification number that identifies the end sector related to the read and/or write of the data;
reading an identification number of the next sector of the end sector when data of the end sector corresponding to the acquired end sector identification number is read and/or written;
determining whether the read-out identification number of the next sector is consecutive to said end sector identification number; and
outputting the data read from the end sector, or alternatively receiving from the outside the data to be written into the end sector, when determined as consecutive.

12. A method of data read and write using a disk apparatus wherein data is read from and/or written into a track on a disk on each sector, comprising the steps of:
acquiring an end sector identification number that identifies the end sector related to the read and/or write of the data;
reading an identification number of the next sector and an identification number of the preceding sector relative to the end sector when data of the end sector corresponding to the acquired end sector identification number is read and/or written;
determining whether the identification number of the next sector and the identification number of the preceding sector having been read are consecutive to said end sector identification number; and
outputting the data read from the end sector, or alternatively receiving from the outside the data to be written into the end sector, when determined as consecutive.

13. A method of data read and write using a disk apparatus wherein data is read from and/or written into a track on a disk on each sector, comprising the steps of:
acquiring an end sector identification number that identifies the end sector related to the read and/or write of the data;
generating a new end sector identification number by incrementing by unity the end sector identification number, when data of the end sector corresponding to the acquired end sector identification number is read and/or written;
determining whether the sector identification numbers up to the generated new end sector identification number are consecutive to each other; and
outputting the data read from the other sectors with excluding the data read from the sector corresponding to the new end sector identification number, or alternatively receiving from the outside the data to be written into the sectors other than the sector corresponding to the new end sector identification number, when determined as consecutive.

14. A method of data read and write according to claim 11, further comprising the steps of:
determining whether off-track retry has been generated before the end of a sector located at a position generated by decrementing by unity the acquired end sector identification number; and
reading the identification number of the next sector of said end sector only when determined that off-track retry has been generated.

15. A method of data read and write according to claim 12, further comprising the steps of:
determining whether off-track retry has been generated before the end of a sector located at a position generated by decrementing by unity the acquired end sector identification number; and
reading the identification number of the next sector and the identification number of the preceding sector relative to said end sector only when determined that off-track retry has been generated.

16. A method of data read and write according to claim 11, further comprising the step of:
executing data read and write on the basis of a data transfer pointer indicating a sector serving as a data transfer target and a read-write pointer indicating a sector serving as a target of data read and write, wherein
said data transfer pointer indicates a range extending from a read start sector to said end sector, while said read-write pointer indicates a range extending from a read-write start sector to a predetermined sector that follows said end sector.

17. A method of data read and write according to claim 12, further comprising the step of
executing data read and/or write on the basis of a data transfer pointer indicating a sector serving as a data transfer target and read-write pointer indicating a sector serving as a target of data read and/or write, wherein
said data transfer pointer indicates a range extending from a read start sector to said end sector, while said read-write pointer indicates a range extending from a read-write start sector to a predetermined sector that follows said end sector.

18. A method of data read and write according to claim 13, further comprising the step of:
executing data read and write on the basis of a data transfer pointer indicating a sector serving as a data transfer target and a read-write pointer indicating a sector serving as a target of data read and write, wherein
said data transfer pointer indicates a range extending from a read start sector to said end sector, while said read-write pointer indicates a range extending from a read-write start sector to a predetermined sector that follows said end sector.

19. A method of data read and write according to claim 14, further comprising the step of:
executing data read and write on the basis of a data transfer pointer indicating a sector serving as a data transfer target and a read-write pointer indicating a sector serving as a target of data read and write, wherein
said data transfer pointer indicates a range extending from a read start sector to said end sector, while said read-write pointer indicates a range extending from a read-write start sector to a predetermined sector that follows said end sector.

20. A method of data read and write according to claim 15, further comprising the step of
executing data read and write on the basis of a data transfer pointer indicating a sector serving as a data transfer target and a read-write pointer indicating a sector serving as a target of data read and write, wherein
said data transfer pointer indicates a range extending from a read start sector to said end sector, while said read-write pointer indicates a range extending from a read-write start sector to a predetermined sector that follows said end sector.
